(19) United States
(12) Patent Application Publication
(10) Pub. No.: US 2012/0174152 A1
(43) Pub. Date: Jul. 5, 2012

(54) METHODS AND APPARATUS OF INSERTING ADVERTISEMENT

(75) Inventors: Zhou Ye, Foster City, CA (US); Pei-Chuan Liu, Taipei City (TW)

(73) Assignee: CYWEE GROUP LIMITED, Tortola (VG)

(21) Appl. No.: 12/983,842

(22) Filed: Jan. 3, 2011

(51) Int. Cl. H04N 7/10

(52) U.S. Cl. 725/36

(57) ABSTRACT

A method of inserting advertisement into a video stream includes receiving a request, by an advertisement insertion device, for transferring the video stream to a set-top box or a TV dongle; determining a type of the video stream; downloading an advertisement according to the type of the video stream; and inserting the advertisement into the video stream.

### BACKGROUND OF THE INVENTION

1. Field of the Invention

The present invention generally relates to methods and apparatus of inserting advertisement when synchronizing advertisement insertion devices to large displays such as televisions, LCD external monitors or projectors.

2. Description of the Prior Art

Synchronizations or projections of video streams from mobile devices (to display its content) to large displays may become popular in the future and bring convenience to many users. For example, TV programs, clips (e.g., YouTube videos) or movies may be downloaded by an advertisement insertion device (e.g., a cellular phone) and then transferred to a TV for displaying on the big TV screen (or relatively big with respect to the screen of the advertisement insertion device). In these applications, the video streams may, for example, be converted into motion jpeg or H.264 format and transferred wirelessly via WiFi, Wireless HDMI or WiMo protocols to the TV.

Conventionally, advertisements (ads) may be inserted into the video stream either by being combined with specific piece (s) of the video streams (e.g., TV programs, clips or movies), or pasted onto a part of a frame of the video streams. In this way, the advertisements may merely be configured as for the purpose of broadcasting or delivering the information or the ideas of the advertisements themselves, but may not provide information which may relate to the video streams the users are watching. As a result, the effectiveness of the advertisements may be reduced since the inserted advertisements may not be of the user's interest.

It may therefore be desirable to have an advertisement insertion apparatus and/or a method of providing advertisements of the interest of the users, who are watching the big screen(s) displaying the content projected from their mobile devices.

### SUMMARY OF THE INVENTION

It is therefore an objective of the present invention to provide methods and apparatus of inserting advertisement.

The present invention discloses a method of inserting advertisement into a video stream, which comprises receiving a request, by an advertisement insertion device, for transferring the video stream to a set-top box or a TV dongle; determining a type of the video stream; downloading an advertisement according to the type of the video stream; and inserting the advertisement into the video stream.

The present invention further discloses an advertisement insertion apparatus, which comprises a first module configured to receive a request for transferring a video stream to a set-top box or a TV dongle; a second module configured to determine a type of the video stream; a third module configured to download an advertisement according to the type of the video stream; and a forth module configured to insert the advertisement into the video stream.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an apparatus for inserting an advertisement according to an example of the present invention.

FIG. 2 is a schematic diagram illustrating an apparatus for inserting an advertisement according to another example of the present invention.

FIG. 3 is a schematic diagram illustrating an apparatus for inserting an advertisement according to yet another example of the present invention.

FIG. 4 is a schematic diagram illustrating an apparatus for inserting an advertisement according to still another example of the present invention.

FIG. 5 is a flowchart illustrating a method of inserting an advertisement according to an example of the present invention.

FIG. 6 is a flowchart illustrating a method of inserting an advertisement according to another example of the present invention.

FIG. 7 is a flowchart illustrating a method of inserting an advertisement according to yet another example of the present invention.

### DETAILED DESCRIPTION

Reference will now be made in detail to present examples of the present invention illustrated in the accompanying drawings. Wherever possible, the same reference numbers will be used throughout the drawings to refer to the same or like portions. It should be noted that the drawings are in greatly simplified form and are not to precise scale.

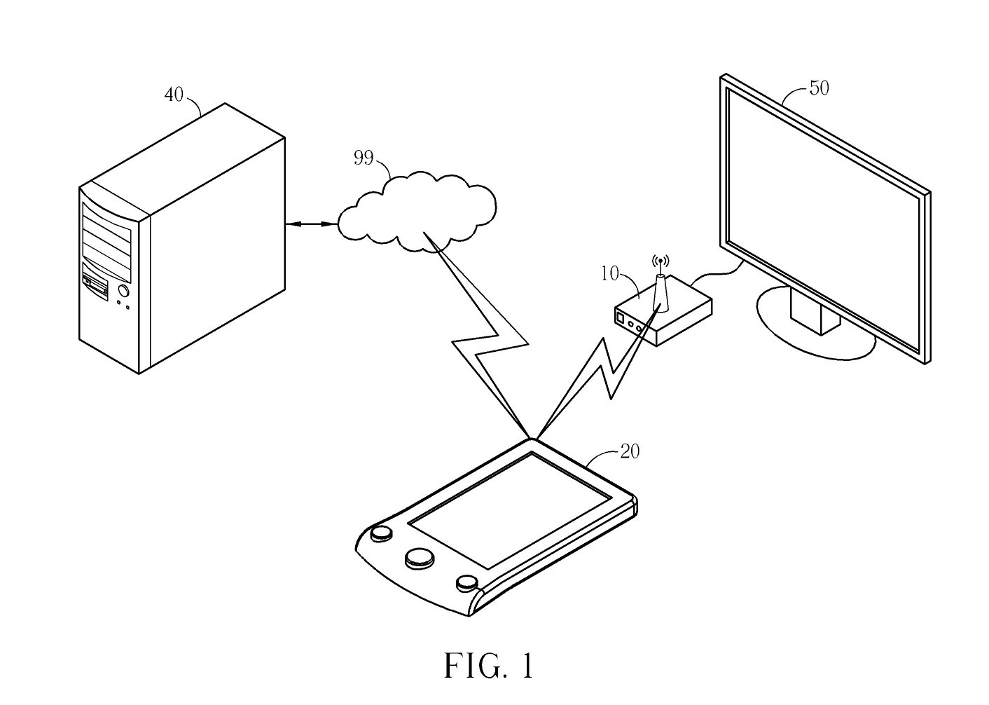

FIG. 1 is a schematic diagram illustrating an apparatus for inserting an advertisement according to an example of the present invention. Referring to FIG. 1, examples of an advertisement insertion device 20 may include, but is not limited to at least one of a cellular phone, a personal digital assistant (PDA), a portable media player, a cloud terminal, a personal computer or a laptop computer. The advertisement insertion device 20 may be configured to transfer content stored in its storage or generated after computing to a set-top box 10 for displaying the content on the screen of an external monitor 50. The set-top box 10 may be configured to couple with/to the external monitor 50. Examples of the external monitor 50 may include, but is not limited to at least one of a TV and an LCD display.

In one example, a user may play a game configured in the advertisement insertion device 20, and the content of the game may be transferred to the external monitor 50 for being displayed since the display of the advertisement insertion device 20 may not be good or big enough in size for playing the game with best quality. In this example, the advertisement insertion device 20 may further include a few motion sensors including, but not limited to, an accelerometer, a gyroscope or a magnetic sensor, and the motion sensors are contributive to playing the game in 3-dimensional motion or gesture way.

In another example, the user may use the advertisement insertion device 20 to transfer a video stream (e.g., a movie clips, TV clips, music videos) downloaded from internet 99 to the set-top box 10 and then display the video on the external monitor 50.

From the abovementioned examples, regardless of whether the user want to use the external monitor 50 to display a game or video stream in the advertisement insertion device 20, after the user decided which content to display on the external monitor 50, the related advertisement maybe downloaded from an advertisement server 40 through internet 99 by the advertisement insertion device 20. In one embodiment of the present invention, a widget can be downloaded and installed in the advertisement insertion device 20 from, but is not limited to, internet 99 (e.g., App Store) or be provided voluntarily by an advertisement provider (who owns the advertisement server 40). The widget can be configured to determine the type of the content, so as to determine which advertisement to download. Furthermore, the buffering time of the advertisement can be determined by the advertisement insertion device 20 or the advertisement provider. After the advertisement is downloaded, either the advertisement insertion device 20 or the set-top box 10 may insert the advertisement into the video stream at the beginning, in the middle or at the end of the video stream, depending on the commercial consideration of the advertisement provider. After which, the inserted video stream may be displayed with the external monitor 50. In this way, the advertisement provider can easily provide related advertisement which the user may be interested in with the video stream.

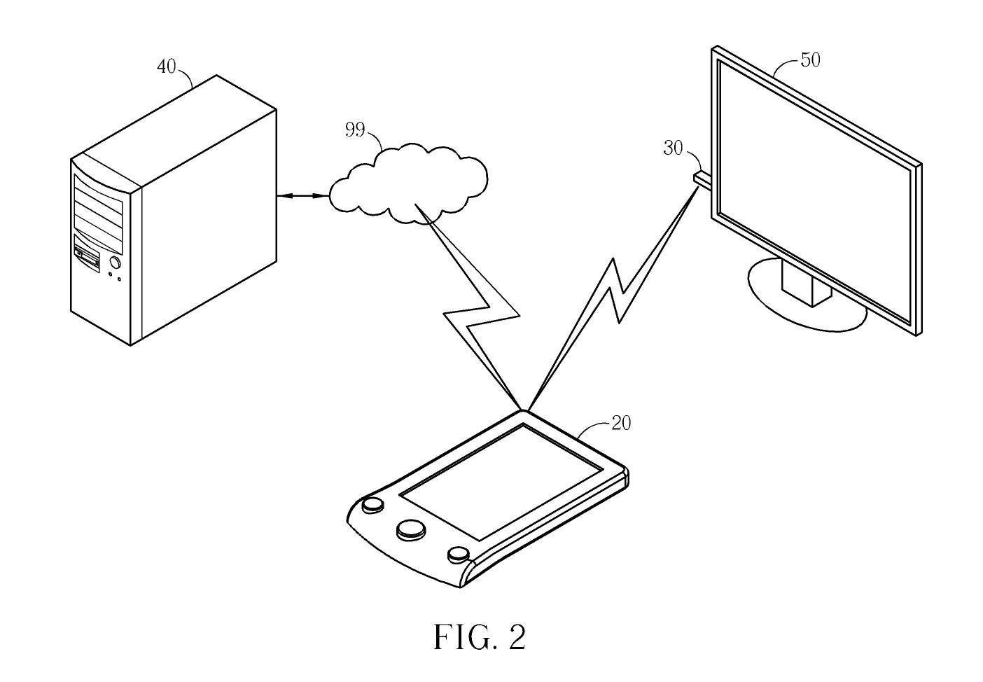

FIG. 2 is a schematic diagram illustrating an apparatus for inserting advertisements according to another example of the present invention. Referring to FIG. 2, the scenario maybe similar to FIG. 1 except that, for example, the set-top box 10 may be replaced by a TV dongle 30.

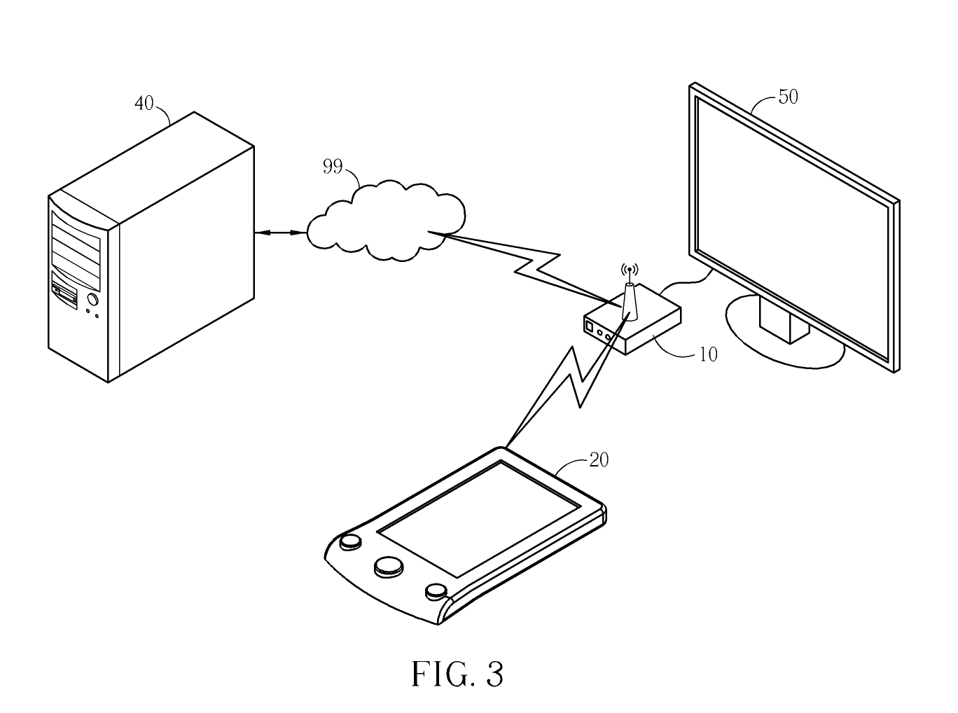

FIG. 3 is a schematic diagram illustrating an apparatus for inserting advertisements according to yet another example of the present invention. Referring to FIG. 3, the scenario maybe similar to FIG. 1 except that, for example, the set-top box 10 may download the advertisement related to the content actively since the content can be determined by the set-top box 10. After downloading the advertisement, the set-top box 10 inserts the advertisement into the video stream at the beginning, in the middle or at the end of the video stream.

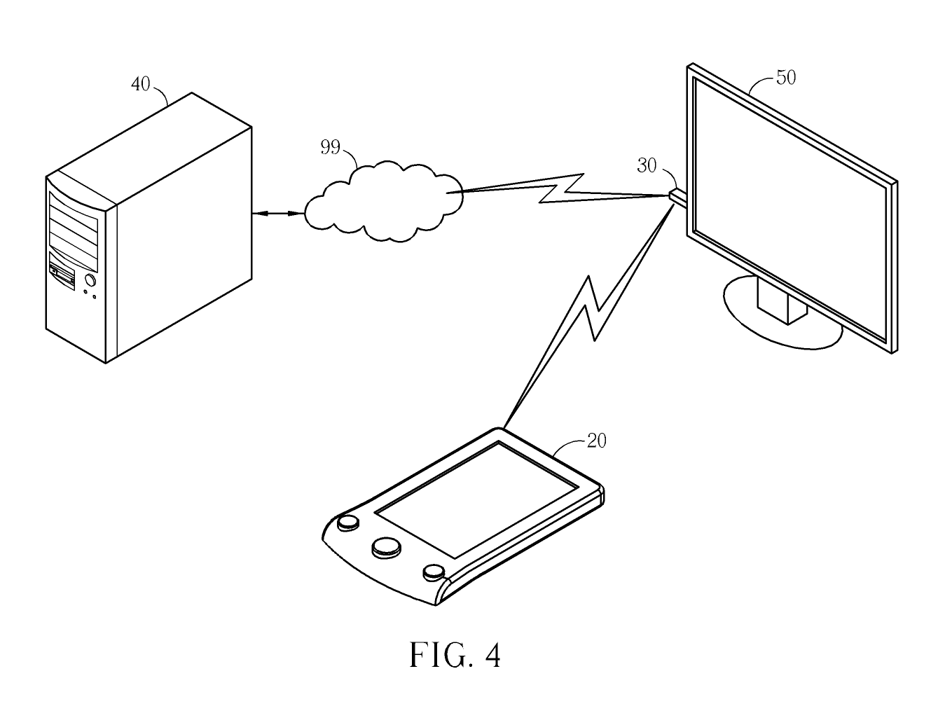

FIG. 4 is a schematic diagram illustrating an apparatus for inserting advertisements according to still another example of the present invention. Referring to FIG. 4, the scenario maybe similar to FIG. 3 except that, for example, the set-top box 10 maybe replaced by the TV dongle 30.

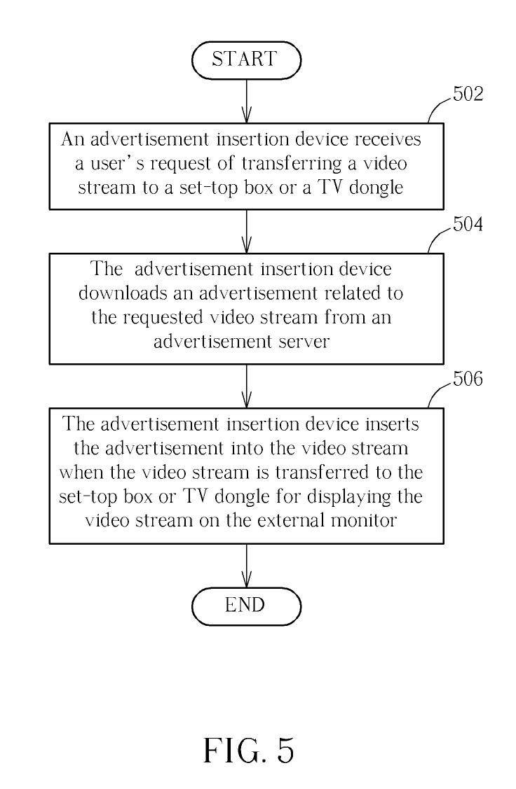

FIG. 5 is a flowchart illustrating a method of inserting an advertisement according to an example of the present invention. Referring to FIG. 5, at step 502, an advertisement insertion device 20 may receive a user's request of transferring a video stream to a set-top box 10 or a TV dongle 30 for displaying the video stream on an external monitor 50. At step 504, the advertisement insertion device 20 may download an advertisement related to the requested video stream from an advertisement server 40. At step 506, the advertisement insertion device 20 inserts the advertisement into the video stream at the beginning, in the middle or at the end of the video stream when the video stream is transferred to the set-top box 10 or TV dongle 30 for displaying the video stream on the external monitor 50.

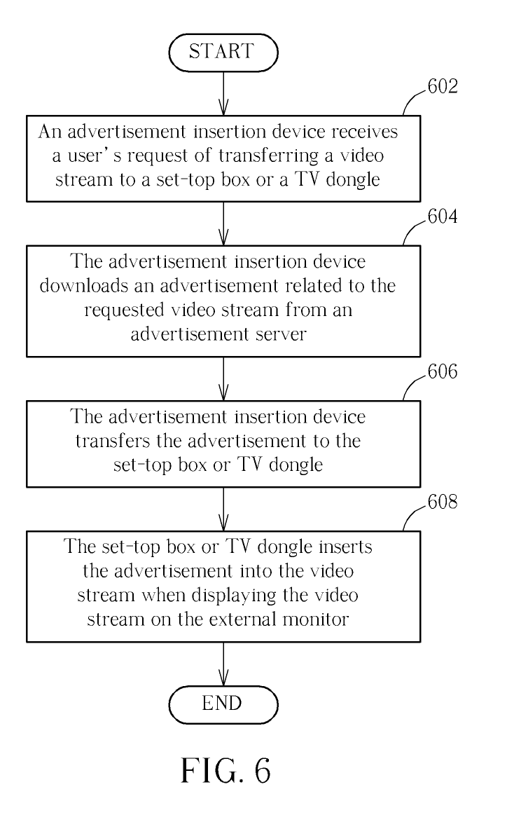

FIG. 6 is a flowchart illustrating a method of inserting an advertisement according to another example of the present invention. Referring to FIG. 6, at step 602, an advertisement insertion device may receive a user's request of transferring a video stream to a set-top box 10 or a TV dongle 30 for displaying the video stream on an external monitor 50. At step 604, the advertisement insertion device 20 downloads an advertisement related to the requested video stream from an advertisement server 40. At step 606, the advertisement insertion device 20 transfers the advertisement to the set-top box 10 or TV dongle 30. At step 608, the set-top box 10 or TV dongle 30 inserts the advertisement into the video stream at the beginning, in the middle or at the end of the video stream when displaying the video stream on the external monitor 50.

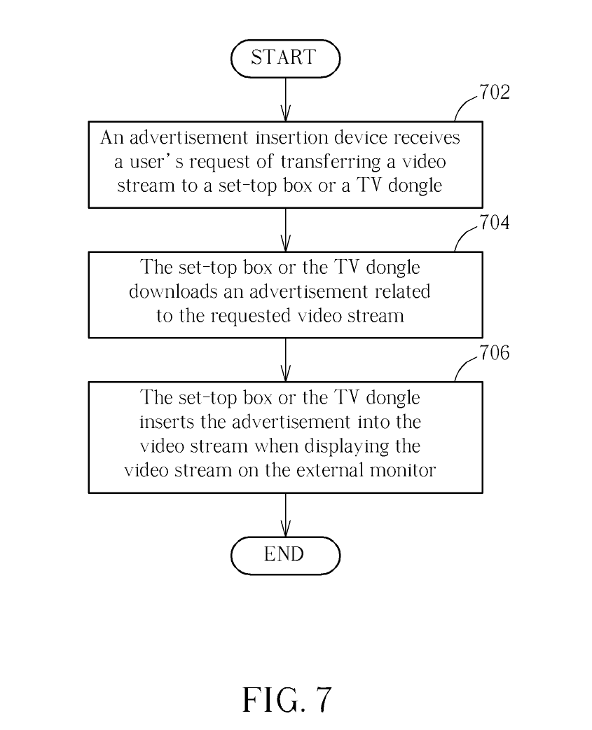

FIG. 7 is a flowchart illustrating a method of inserting advertisement according to yet another example of the present invention. Referring to FIG. 7, at step 702, an advertisement insertion device 20 may receive a user's request of transferring a video stream to a set-top box 10 or a TV dongle 30 for displaying the video stream on an external monitor 50. At step 704, an advertisement related to the requested video stream is downloaded by the set-top box 10 or the TV dongle 30, instead of the advertisement insertion device 20 as shown in FIG. 5 and FIG. 6. At step 706, the set-top box 10 or the TV dongle 30 inserts the advertisement into the video stream at the beginning, in the middle or at the end of the video stream when displaying the video stream on the external monitor 50.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

Further, in describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

Those skilled in the art will readily observe that numerous modifications and alterations of the device and method may be made while retaining the teachings of the invention.

What is claimed is:

1. A method of inserting advertisement into a video stream, the method comprising:
receiving a request, by an advertisement insertion device, for transferring the video stream to a set-top box or a TV dongle;
determining a type of the video stream;
downloading an advertisement according to the type of the video stream; and
inserting the advertisement into the video stream.

2. The method of claim 1, wherein the type of the video stream is determined by the advertisement insertion device.

3. The method of claim 2, wherein the advertisement insertion device downloads the advertisement according to the type of the video stream.

4. The method of claim 3, wherein the advertisement is inserted into the video stream by the advertisement insertion device.

5. The method of claim 3, wherein the advertisement is inserted into the video stream by the set-top box or the TV dongle.

6. The method of claim 1, wherein the type of the video stream is determined by the set-top box or the TV dongle.

7. The method of claim 6, wherein the set-top box or the TV dongle downloads the advertisement according to the type of the video stream.

8. The method of claim 7, wherein the advertisement is inserted into the video stream by the set-top box or the TV dongle.

9. An advertisement insertion apparatus comprising:
a first module configured to receive a request for transferring a video stream to a set-top box or a TV dongle;
a second module configured to determine a type of the video stream;
a third module configured to download an advertisement according to the type of the video stream; and
a forth module configured to insert the advertisement into the video stream.

10. The advertisement insertion apparatus of claim 9, wherein the first module, second module, third module and forth module are included in an advertisement insertion device.

11. The advertisement insertion apparatus of claim 9, wherein the first module, second module and the third module are included in the advertisement insertion device, and the forth module is included in the set-top box or the TV dongle.

12. The advertisement insertion apparatus of claim 9, wherein the first module is included in the advertisement insertion device, and the second module, third module and the forth module are included in the set-top box or the TV dongle.
